(19) United States
(12) Patent Application Publication
(10) Pub. No.: US 2008/0033890 A1
(43) Pub. Date: Feb. 7, 2008

(54) AGGREGATION OF INDIVIDUAL INVESTMENTS

(75) Inventor: Inderjeet Singh, San Jose, CA (US)

Correspondence Address: PERKINS COIE LLP, P.O. BOX 2168, MENLO PARK, CA, 94026, US

(73) Assignee: Inderjeet Singh, San Jose, CA (US)

(21) Appl. No.: 11/772,038

(22) Filed: Jun. 29, 2007

Related U.S. Application Data
(60) Provisional application No. 60/821,387, filed on Aug. 3, 2006.

(51) Int. Cl. G06Q 40/00

(52) U.S. Cl. 705/36 R

(57) ABSTRACT

The present invention teaches a variety of systems, methods and apparatus for aggregation of individual investments. One system is a network-based service that enables individual investors to collaborate on the world wide web or another network in order to exert market moving forces with the financial clout of large investment banks, high net worth investors, mutual funds or hedge funds. The structure of the service mimics how individuals communicate with each other about ideas and advice about a variety of important decisions. The intent of the service is to enable large numbers individual investors to create a community for the purpose of creating profit from trading in market traded securities. The volume of individuals that can come together on a medium such as the world wide web to create a large community will potentially drive the power of the community to generate profit along with influence.

### RELATED APPLICATIONS

This application claims priority to U.S. Provisional Patent Application No. 60/821,387, filed Aug. 3, 2006, and entitled “AGGREGATION OF INDIVIDUAL INVESTMENTS,” by Inderjeet Singh, and is hereby incorporated herein by reference.

### BACKGROUND

Capitalism is a system founded on individual rights. In the current US financial market, over the past 50 years, the rights and clout of the individual investor have been systematically eroded. John C Bogle, former Chairman of The Vanguard Group said “The amazing disappearance of the individual stockholder as the backbone of the U.S. stock market has been one of the least recognized but most profound trends of the last half-century. As shown in the chart nearby, direct ownership of stocks by American households has declined from 91% in 1950 to just 32% today. The 9% ownership stake held by financial institutions in 1950 crossed the 50% mark in 1983, and now totals 68% of all stocks. It is hard to imagine that our earlier society dominated by individual stock ownership will ever return.”

FIG. 1 illustrates shareholdings by direct owners of stock over time. Graph 100 illustrates the decline in stock ownership by direct owners—individuals over the latter half of the 20th century. As is apparent, institutional control of corporations has gradually become the norm.]

The net effect of this trend is that the most clout over investment profits is restricted to either large financial corporations, hedge funds, mutual funds or extremely rich investors. Volume and size drives the financial markets and these factors are controlled by institutional investors. The individual investor has little or no control over the performance of their investment holdings in private accounts, retirement or pension funds.

The following are examples of abuses of the power that result from the financial clout that is wielded by the institutional investors.
1. In the dot-com boom there were well publicized events when analysts dumped their stock while recommending the same to individual investors
2. The debacle of the retirement and pension funds for Enron resulting from insiders dumping stock while the individual investors saw their investments deplete to nothing.
3. The 2006 stock option backdating scandals wherein company profits were inflated through such, thereby artificially painting a rosy picture of various firm's finances.

Thus, it may be useful to provide a system which allows individual investors to aggregate their investing resources behind various ideas, thereby potentially reducing the influence of large entities in the financial markets and increasing the influence of individuals.

### BRIEF DESCRIPTION OF THE DRAWINGS

The present invention is illustrated by way of example in the accompanying drawings. The drawings should be understood as illustrative rather than limiting.

FIG. 1 illustrates shareholdings by direct owners of stock over time.

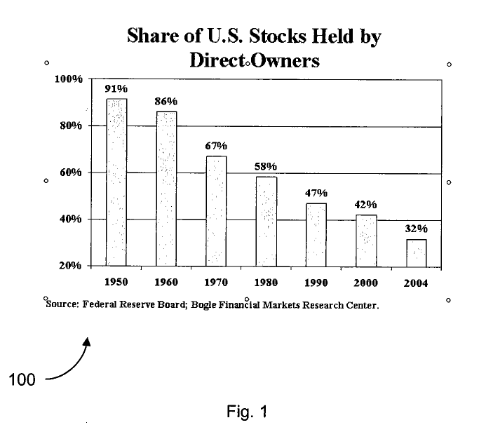

FIG. 2 illustrates an embodiment of a system for implementing investment ideas.

FIG. 3 illustrates an embodiment of a process of subscribing to an investment idea.

FIG. 4 illustrates an embodiment of a process of providing an investment idea.

FIG. 5 illustrates an embodiment of a process of presenting and executing an investment idea.

FIG. 6A illustrates an embodiment of a graphical user interface for presentation of investment information.

FIG. 6B illustrates another embodiment of a graphical user interface for presentation of investment information.

### DETAILED DESCRIPTION

A system, method and apparatus is provided for aggregation of individual investments. In one embodiment, the system is a network-based service that enables individual investors to collaborate on the world wide web or another network in order to exert market moving forces with the financial clout of large investment banks, high net worth investors, mutual funds or hedge funds. The structure of the service, in this embodiment, is to mimic how individuals communicate with each other about ideas and advice about a variety of important decisions. The intent of the service is to enable large numbers individual investors to create a community for the purpose of creating profit from trading in market traded securities. The volume of individuals that can come together on a medium such as the world wide web to create a large community will potentially drive the power of the community to generate profit along with influence.

In another embodiment, the system is an internet-based service that enables individual investors to collaborate on the world wide web in order to exert market moving forces with the financial clout of large investment entities. Similarly, the structure of the service, in this embodiment, is to mimic how individuals communicate with each other about ideas and advice about a variety of important decisions. Such a service enables large numbers of individual investors to create a community for the purpose of creating profit from trading in market traded securities.

In yet another embodiment, a method is presented. The method includes receiving an investment idea. The method also includes detecting a trigger condition of the investment idea. The method further includes executing the investment idea for a group of subscribers to the investment idea. The method may be implemented by a system or machine, and may be embodied as instructions for a processor in a machine-readable medium.

In still another embodiment, a method is presented. The method includes creating an investment idea. The method also includes receiving signups to the investment idea. The method further includes executing the idea. Such a method may likewise be implemented by a system or a network of devices, for example.

The specific embodiments described in this document represent examples or embodiments of the present invention, and are illustrative in nature rather than restrictive. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

In one embodiment, users register and may then log in to the system—the system is implemented as a website. Each user of the service is given an ID and password to enter the web-site. Each user enters their name, address, phone numbers and email addresses. Other identifying information may also be required. Each user enters userid and passwords to one or more brokerage accounts that hold their funds (e.g. Datek, Ameritrade, ETrade, Charles Schwab etc.). Each user also signs a legal agreement with the system authorizing the system to conduct only authorized financial transactions electronically using these brokerage accounts and not without explicit authorization by the user. Only individuals are allowed to create accounts in such a system. Via a legal agreement, user certifies their status as an individual investor and not a business or corporation (either profit or not-for-profit). Note that various types of networks may be used to implement various embodiments, and discussions of an embodiment using the world wide web and/or internet do not preclude use of other networks.

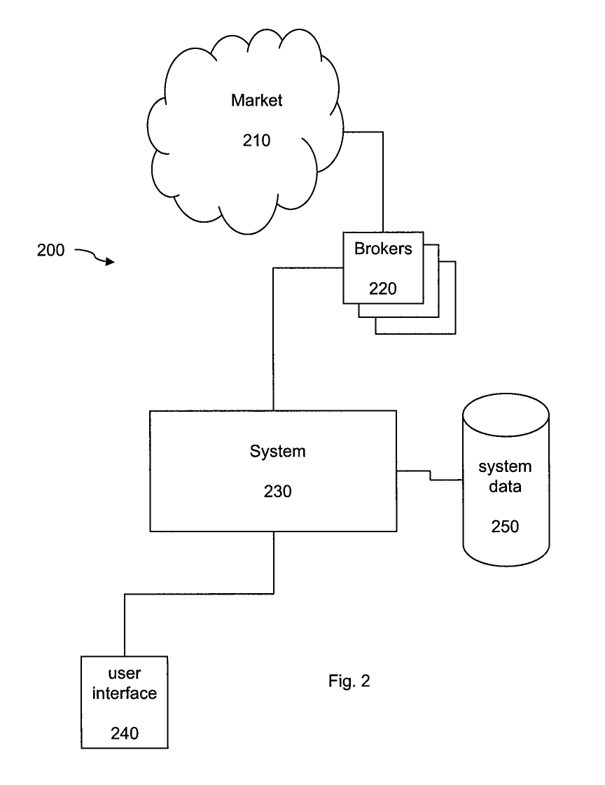

FIG. 2 illustrates an embodiment of a system for implementing investment ideas. System 200 includes a financial securities market 210, brokers 220, system 230 (the investment system/community), a user interface 240 and system data 250. System 230 is an investment system which allows users to provide ideas, promote those ideas and subscribe to such ideas. The ideas may take on a variety of forms, but are all related to investment in publicly traded securities. System 230 operates through brokers 220 to execute trades on market 210. Thus, system 230 is not a brokerage system—it allows for exchange of ideas. System 230 interacts with users (individual investors) through a user interface 240—through which ideas may be communicated, commented upon, and subscribed to, among other actions. System data 250 tracks investment ideas, including the actual idea, who has subscribed, and commentary, for example. System data 250 also tracks user information, including what ideas the user has proposed, success rates, trust ratings, and other related public and private information.

Thus, a first user may submit an idea through user interface 240. That idea may be vetted by other users through user interface 240, with the system 230 further providing information about a trust rating for the first user and potentially historical information related to yields of previous ideas from the first user. The first user and other users may subscribe to the idea, and cause brokers 220 (at which the first user and other users have accounts) to execute trades in market 210 based on the idea.

Within such an embodiment, any investor may generate an idea and for participation from the entire community of users on the web-site. Investment ideas have one or more rules. In one embodiment, each rule has at least the following parameters, although other embodiments may use different parameters:
1. Security: user picks from a list of securities actively traded on any stock exchange anywhere in the world. These may be equities, fixed income, derivatives, ETFs, mutual funds etc.
2. Action: Buy or Sell
3. Type: Price, Ratio, Differential Volume, Differential Price, Differential Ratio
4. Parameters: The actual criteria involved in triggering the action.

The parameters may vary depending on the type of criteria involved. Thus, for a trade based on price, the parameters may include price and volume (Absolute volume or percentage of market cap for example). For a trade based on a ratio, the parameters may involve ratio type (various ratios for the security), ratio value and volume (Absolute volume or percentage of market cap, e.g.)

Similarly, a trade based on differential volume—example (Buy 1,000,000 shares of GE if Volume in the past week is above 20,000,000) may involve a time period (Past Week, Past N Weeks, Past Month, Past N Months, Past Year, e.g.) and volume (Absolute volume or percentage of market cap, e.g.) Likewise, for a trade based on a price differential—(example buy 5% shares of GE's market cap if price goes down by $4 or more in the past 7 days), parameters may include volume (Absolute volume of percentage of market cap), differential in price (absolute or percentage), start date, period, and period unit of measure. Also, for a trade based on a ratio differential—(example buy 1,000,000 shares of GE if P/E ratio drops by more than 1% in the past month), the parameters may include volume (Absolute volume of percentage of market cap), ratio type, differential in ratio (absolute or percentage), start date, period and period unit of measure.

Note that in most cases the actual date and time upon which the idea will be executed is unpredictable. It depends upon the actual parameters for the idea being satisfied, which are dependent upon current and past history of the security on the market and also on the level of participation in the idea. The service (e.g. system 230) is responsible for monitoring the markets in real-time and detecting the events that result in the execution of the investment idea. The genesis of the idea may include one or more of these rules. For example, an idea may involve a Buy of 5% of GE at a P/E of 14 and Sell the same at P/E of 15.

The investment idea generator may indicate through the user interface 240 that they want to allow participants only with a certain level of trust rating (trust ratings are discussed below) to participate. The system 230 honors this request and does not allow users with lower trust ratings to participate in the investment idea. The user creating the investment idea is given the opportunity by the system 230 to describe the profit potential of the idea itself in his/her own words. This, in conjunction with the trust and past profitability ratings for the user, are the “marketing vehicles” for the user in the community to gain adequate participation. Upon creation, the idea is complete, stored in system data 250 and active for participants to join the idea. Participants may also comment on the idea in some embodiments.

Any user in the community can suggest new kinds of ideas (not ideas themselves). The system 230 allows the deployment of the new idea types and makes them available to the community to generate the ideas based on the new idea structure. Each user is then related to one or more ideas. Ideas are related to one or more securities. For example, a user may suggest a new kind of idea that is based on the movement in the prices of call options for a given security.

Any user can use the user interface 240 to search the system data 250 to find users (by trust rating, name, profitability etc.) or ideas (by security, by volume, by type etc.), for example. Other search parameters such as a minimum commitment or industry group may also be available, for example. A free text search may allow for searching the web site that takes into account the popularity of the objects (users, ideas etc.) in the community as well. If required, a user may elect to search the web-site using specific parameters in a specific sort order instead of relying on the popularity of objects. Such searches may lead to discovery by the user of investment ideas, or of information about how other users have performed historically in pursuing or creating investment ideas.

Any user, after searching for an investment idea may review the idea. This may include the parameters of the idea, current and past market performance of the security and current participation levels in one embodiment. Moreover, this may include restrictions on the idea which the user may meet (e.g. minimum investment level) but which the user may not wish to meet.

Any user in the community may elect to participate in an active investment idea. When participating in the idea, the user provides various information in such an embodiment. The amount of funds committed is provided. The brokerage account that will be used to execute the trades when execution is triggered is provided or designated. A legal agreement between the system (its proprietor) and the user authorizing the system to cause brokers to execute the transactions specified in the investment idea when the trigger for the service is reached is also provided. The individual may elect to un-participate or de-commit from an investment idea at any time.

In other embodiments, the execution of the idea is accomplished by other means than immediately committing the transaction. For example, idea execution could mean a notification is sent to each participant, and each participant could then effectuate the transaction as desired, for example by executing the actual trade(s) independently with their own brokerage account. The notification could be sent by any suitable mechanism such as email, telephone call, voicemail, SMS message, etc.

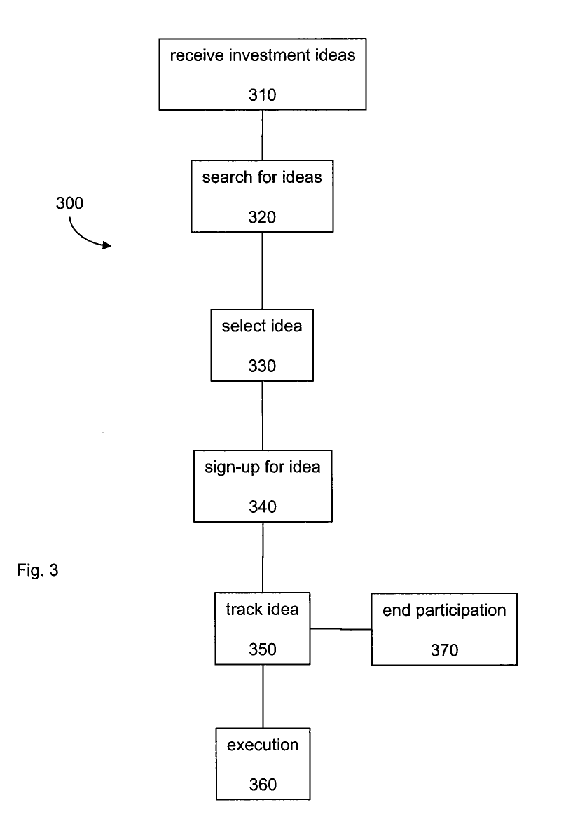

FIG. 3 illustrates an embodiment of a process of subscribing to an investment idea. Process 300 includes receiving investment ideas, searching for such ideas among a repository of ideas, selecting an idea, signing up for the idea, tracking the idea, executing the idea, and ending participation in the idea if appropriate. Process 300 and other methods of this document are composed of modules which may be rearranged into parallel or serial configurations, and may be subdivided or combined. The method may include additional or different modules, and the modules may be reorganized to achieve the same result, too.

Process 300 is illustrated as beginning with receipt of investment ideas at module 310. Process 300 and other processes of this document may operate more in the nature of a repeating cycle, entered at various points, but module 310 provides a convenient starting point and linear presentation provides a simple view of the process. The investment ideas may be maintained in some form of repository (e.g. a database). At module 310, a search for ideas occurs, such as in response to a user request. At module 330, an idea is selected, such as from a list of search results or a list of recently submitted ideas for example.

If the idea is deemed suitable, a user signs up for the idea at module 340—committing to invest funds or resources as part of a group participating in the investment idea. At module 350, the idea is tracked, with updated information about whether the idea has been triggered, remains dormant, or has been cancelled, for example. During this tracking phase, the user may decommit or end participation in the idea at module 370. Otherwise, the idea may be triggered, with execution of the idea occurring at module 360. At this point, the user may be involved a binding commitment, for example, without the option of ending participation. Alternatively, the idea may involve essentially instantaneous execution—the idea is simply a purchase or sale for example, and when the related trade occurs, the idea has reached fruition.

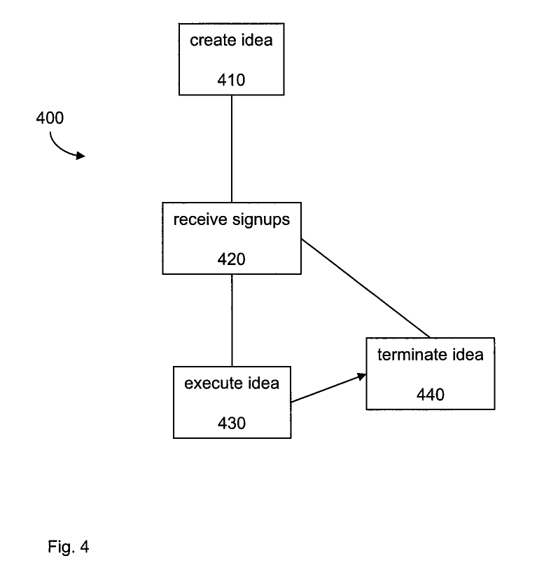

FIG. 4 illustrates an embodiment of a process of providing an investment idea. A user may provide an idea with relative ease. Process 400 includes creating the idea, receiving signups for the idea, executing the idea and/or terminating the idea. Whether the idea receives signups, and is executed or terminated, is in part up to the creator of the idea and in part up to the marketplace.

Process 400 initiates with a user creating an investment idea at module 410. This may take many forms, as discussed elsewhere in this document. At module 420, signups for the idea are received. If the user changes opinion about the merits of the idea, the idea may be terminated at module 440 while signups are received—though this would not prevent another user from initiating the same or a similar idea. If enough signups are received, or resources committed, at module 430 the idea is executed, either automatically or with consent of the user. During execution, the idea may be terminated at module 440 as well. However, this may require consent of those subscribing to the idea, or it may be automatic based on exit conditions incorporated in the original idea.

With ideas presented and subscribed to, the system then causes execution. In some embodiments, the service monitors market dynamics in real-time and creates software events. The system matches all existing investment idea rules against the real-time information being fed into the system to create an event that will trigger the execution of the investment idea.

With the idea triggered, the service executes the investment idea using the individual brokerage accounts of participants by executing electronic transactions with online brokerages. Interfaces with these brokerages are included in the system. Such brokerage services typically allow for some such interface through an API (application program interface), for example.

In addition, the sequence of execution of the buy or sell transactions may be optimized by execution of the trades in a pattern that is selected by the service or by the individuals participating in the idea for optimization of profit. For example, in order to execute the investment idea to buy 5% of GE, the actual trades might start with an escalating volume over a period of 1 hour, distributing the individual trades over multiple brokerage accounts from different users that participate in the investment idea. Such optimizations can take a variety of forms, and need not be implemented for the system to operate. However, such optimizations may be preferable in most embodiments.

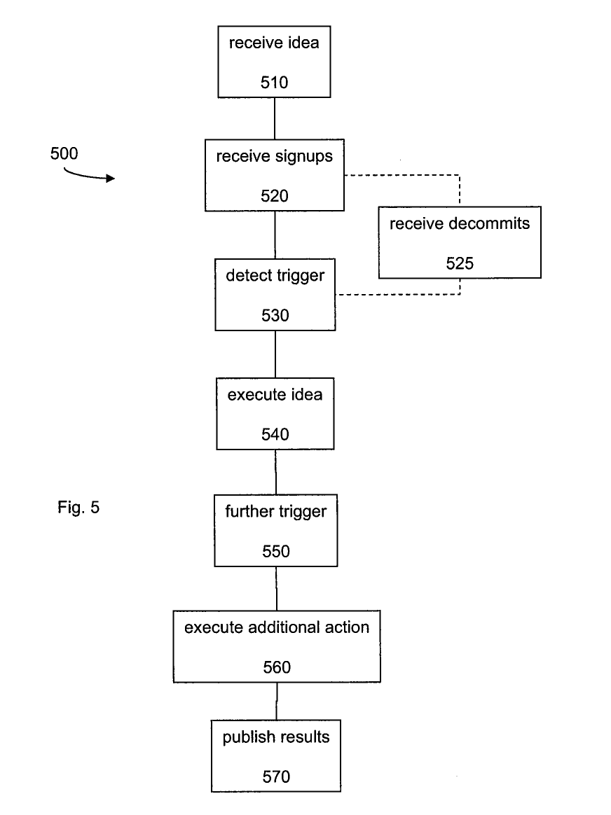

FIG. 5 illustrates an embodiment of a process of presenting and executing an investment idea. Process 500 includes receiving an idea, receiving signups for the idea, receiving decommits for the idea, detecting a trigger for the idea, executing the idea, receiving further trigger(s) and executing further action(s), and publishing results of a completely executed idea. Thus, the system may receive an idea and signups, then automatically execute the idea while providing information about the idea.

Process 500 initiates with receipt of an idea at module 510. At module 520, signups for the idea are received. In the case of users declining to participate after signing up, decommits are received at module 525. At module 530, a trigger for the idea (e.g. a satisfied condition precedent) is detected. At module 540, the idea or an initial phase of the idea is executed—a trade is made, for example. Thus, an idea may involve selling or purchasing a security at a specified price, with the price achieved, the trade may occur.

For complex ideas, including multiple execution phases or steps, a further trigger may be received at module 550. Likewise, an additional action may be executed at module 560. With the idea complete or at a stage to be evaluated, results are published at module 570. Note that modules 550 and 560 may form a loop for some multi-step ideas, and module 550-570 may also form a loop, allowing for continuous monitoring of an idea. Thus, an idea may involve buying a security at a specified price and selling that security at another specified price, with each trade executed upon observance of the price in the market. Another idea may involve acquiring a first small stake at one price for a security, a second larger stake if the price of the security moves to a second price, and then selling the entire stake if the price of the security moves to a designated third price.

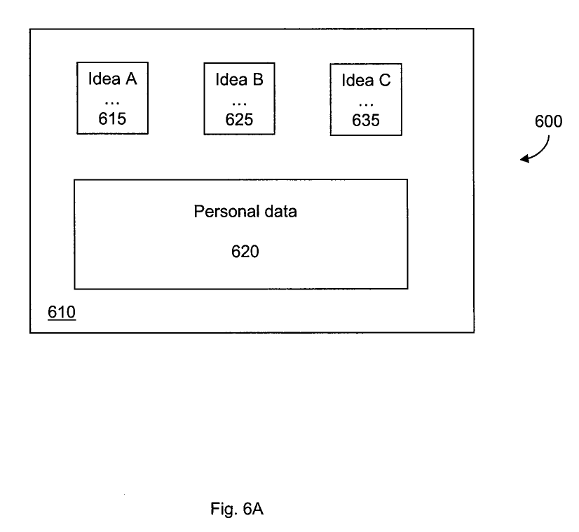

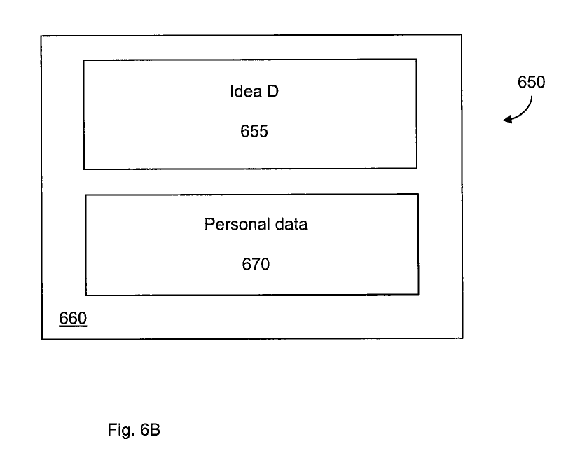

Various user interfaces may be used for the systems and methods described above. FIG. 6A illustrates an embodiment of a graphical user interface for presentation of investment information. User interface 600 includes graphical display 610, which in turn includes idea displays 615, 625 and 635, and personal data display 620. Thus, idea A may be displayed with basic information about the idea in display 615. Similarly, ideas B and C may be displayed with basic information in displays 625 and 635.

In the instance where ideas are being evaluated, this basic information may include a description of the idea and information about what resources are required to signup for the idea. In the instance where a user's subscribed-to ideas are being displayed for informational purposes, the information may involve an expected trigger, underlying market information, and potentially resources committed. In both instances, one may expect that basic information about what security and who promoted or created the idea would be provided.

Personal data 620 may take on a variety of forms, and may or may not be necessary. In one instance, personal data 620 may include basic user information (username, e.g.), financial information for the user (amounts of resources, committed resources), and a history of recent transactions, for example. In another instance, personal data 620 may include recent commitments (and decommits) for the user, for example.

FIG. 6B illustrates another embodiment of a graphical user interface for presentation of investment information. User interface 650 includes graphical display 660, which in turn includes idea display 655 and personal data display 670. Thus, an idea D may be displayed with basic information or detailed information about the idea in display 655. Basic information about idea D may involve a brief description, name of security, name of promoter/creator and whether the idea is accepting subscriptions, for example. More advanced information may include underlying financial data for the security, a detailed description or process flow for the idea, and comments about the idea from other users, for example. Personal data 670 may include various personal information such as subscriber name, financial resources, history, and other information, for example.

In some embodiments, each user will be assigned a rating based upon the trust they exhibit in their behavior on the system. Different actions may trigger upward or downward ticks or increments/decrements on their trust rating. In one embodiment, each user starts with the lowest trust rating. That trust rating then varies over time based on behavior (and potentially feedback from other investors). For example, if a commitment to participate in an investment idea fails because of insufficient funds in the users' brokerage account, that will trigger a downward tick in their trust rating. Similarly, each successful participation in multiple investment ideas will trigger a upward tick in the users' trust rating, for example. These ratings are potentially precious objects to each user in the community because of the marketability of these ratings when the user elects to create or participate in investment ideas.

Along with trust ratings, other statistics or parameters may be tracked. For example, in one embodiment, each user will be assigned profitability ratings based upon the profit generated from their investment ideas. Losses will trigger downward ticks in their profitability ratings whereas profits will trigger upward ticks in the users profitability ratings. As with trust ratings, these ratings are potentially precious objects to each user in the community because of the marketability of these ratings when the user elects to create investment ideas.

One skilled in the art will appreciate that although specific examples and embodiments of the system and methods have been described for purposes of illustration, various modifications can be made without deviating from the present invention. For example, embodiments of the present invention may be applied to many different types of databases, systems and application programs. Moreover, features of one embodiment may be incorporated into other embodiments, even where those features are not described together in a single embodiment within the present document.

What is claimed is:

1. A computer system for implementing an investment strategy for a group of subscribers, the computer system comprising:
means for receiving an investment idea;
means for detecting a trigger condition of the investment idea; and
means for executing the investment idea for a group of subscribers to the investment idea.

2. A method, comprising:
receiving an investment idea;
detecting a trigger condition of the investment idea; and
executing the investment idea for a group of subscribers to the investment idea.

3. The method of claim 2, further comprising:
receiving subscriptions to the investment idea from subscribers.

4. The method of claim 3, further comprising:
receiving cancellations of subscriptions from subscribers.

5. The method of claim 2, further comprising:
detecting a further trigger of the investment idea; and
executing a phase of the investment idea for the group of subscribers responsive to the further trigger.

6. The method of claim 2, further comprising:
receiving subscriptions to the investment idea from subscribers;
detecting a further trigger of the investment idea; and
executing a phase of the investment idea for the group of subscribers responsive to the further trigger.

7. A method, comprising:
creating an investment idea;
receiving signups to the investment idea; and
executing the idea.

8. The method of claim 7, further comprising:
receiving cancellations of signups to the investment idea.

9. The method of claim 7, further comprising:
providing information about a creator of the investment idea.

10. The method of claim 9, further comprising:
tracking data related to success of the investment idea.

11. The method of claim 7, further comprising:
terminating the investment idea.

12. The method of claim 2, further comprising:
implementing the method on a machine in response to instructions, the instructions executed by a processor of the machine, the instructions embodied in a machine-readable medium.

13. The method of claim 2, further comprising:
executing the investment idea through licensed brokerage firms at which subscribers have accounts.

14. The method of claim 2, further comprising:
executing the investment idea through communicating the occurrence of the triggering event to the group of subscribers.
